(19) United States
(12) Patent Application Publication
(10) Pub. No.: US 2004/0018816 A1
(43) Pub. Date: Jan. 29, 2004

(54) Cordless telephone wireless data link systems and methods

(76) Inventor: David Richards, Cedar Park, TX (US)

Correspondence Address: H. Dale Langley, Jr., The Law Firm of H. Dale Langley, Jr. PC, 610 West Lynn, Austin, TX, 78703, US

(21) Appl. No.: 10/205,284

(22) Filed: Jul. 25, 2002

(51) Int. Cl. H04B 1/40; H04Q 7/20

(52) U.S. Cl. 455/74.1; 455/462

(57) ABSTRACT

A cordless communications system enables communications between a mobile communications device and a data network. The system includes a cordless telephone handheld unit communicatively connected to the mobile communications device. A cordless telephone base unit communicatively connects to the cordless telephone handheld unit, via conventional radio frequency channels and technology. The network is communicatively connected to the cordless telephone base unit, for example, by a telephone line capable of providing dial-up or other access to the network. The system permits the mobile device to communicate to and over the network, via link at least in part through the radio frequency channel connecting the handheld unit and the base unit of a conventional cordless telephone.

### BACKGROUND OF THE INVENTION

The present invention generally relates to computing and communications networks, and more particularly, relates to cordless telephone wireless data links for local-area mobile computer communications over global and large networks, including the Internet and other wide area networks (WAN).

Wireless communications permit mobility of devices and users of the devices. Presently, computing devices, as well as other communications units, can access global and other communications networks by various wireless links. The wireless links include cellular, such as CDPD, GPS and others, and also include more local-area wireless channels, such as provided via the 802.11b specification.

The conventional wireless communications technology serves primarily two types of consumers: those requiring available mobile and roaming access over a wide geographic area (such as afforded via cellular, satellite and the like); and those requiring speedy but mobile localized access over a local area (such as afforded via 802.11b devices and variations). The wide geographic area solutions are expensive and typically relatively slow in data rates, because of bandwidth limitations, air loss, and other effects. The speedy localized area mobile solutions are generally fairly expensive and, in any event, many home and small-business consumers do not need or require speed advantages that may be afforded with the greater expense.

Even more, dial-up network access, such as by computers over telephone lines to Internet service providers, remains the predominant networking function desired and implemented by a large majority of consumers, households and small businesses. For example, the AOL network service is probably most popular for individual computer users. Such network service, as AOL and the others accessed through dial-up accounts, can generally provide relatively efficient data rates for those who do not require more speedy network connections. A computer connected to a larger network such as AOL or other communications service provider, via dial-up or similar access, cannot typically benefit from speedier connections at or after the interface with the local telephone loop line or other usual interface. This is the case because the bandwidth, and thus data rates, for communications are limited by the telephone line bandwidth and local interface.

It has not been economically, or technically, justifiable, therefore, for a dial-up or similar network access arrangement to employ localized and mobile wireless capabilities (at least, such capabilities that go beyond infrared, Blue Tooth and similar solutions). In fact, even in the few scenarios—i.e., infrared, Blue Tooth and so forth—in which localized mobile wireless capabilities are provided, additional equipment, software, optical mechanisms and the like are required. Whether or not these additions add significant expense (which, often, the additions do), the additions always require extra elements for operation and are constrained to very limited vicinities of accessibility and operation (thus, limiting extent of mobility).

Most consumers, including individuals, households and the like, have a cordless telephone or can acquire a cordless telephone quite readily and inexpensively. Cordless telephones include a base unit connected to the telephone line via an RX-11 jack or the like. A handheld unit is moveable with respect to its corresponding base unit over a localized geographic vicinity, and the handheld unit communicates with the base unit wirelessly, through radio frequency. Various radio frequency bandwidths are employed for handheld unit and base unit communications in cordless telephones, for example, 900 MHz, 2.4 GHz, and others.

Because of the relatively low expense and ready availability of cordless telephones, and the usual lower-bandwidth communication requirements of most consumers, a low-end (e.g., economical, ready availability, and performance requisites) solution for wireless data communications would be advantageous and desirable.

The present invention remedies, resolves and provides such solutions, and is a significant improvement, advance and advantage in the art and technology.

### BRIEF DESCRIPTION OF THE DRAWINGS

The present invention is illustrated by way of example and not limitation in the accompanying figures, in which like references indicate similar elements, and in which:

FIG. 1 illustrates a communications system including a wide area network accessible by a telephone line, and including a cordless telephone and a data link connecting the handheld unit of the cordless telephone to a computer, according to embodiments of the present invention;

FIG. 2 illustrates a data link for connecting a handheld unit of a cordless telephone to a computer, according to embodiments of the present invention;

FIG. 3 illustrates a circuit of the data link of FIG. 2, according to embodiments of the present invention; and

FIG. 4 illustrates a mobile wireless communications device in communicative connection with a network, via a wireless communications infrastructure, according to embodiments of the present invention.

### DETAILED DESCRIPTION

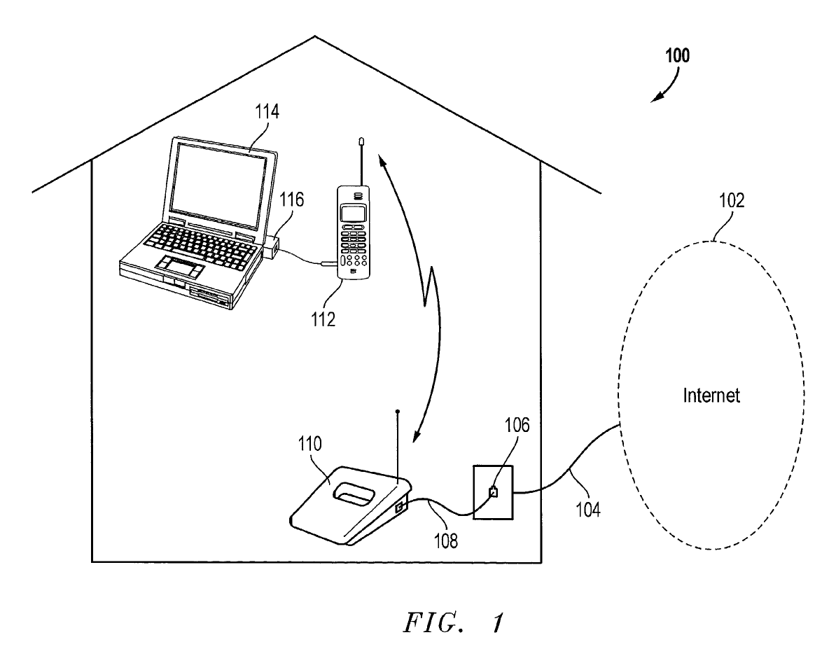

Referring to FIG. 1, a wireless communications system 100 includes a network 102, such as a WAN (for example, the Internet) or other communications network. The network 102 connects to and is accessible via a telephone line 104. The accessibility over the telephone line 104 is, for example, provided by a dial-up service provider account, or a ISDN, DSL or other similar data communications connection via the telephone line 104. The telephone line 104 terminates at a jack 106, such as an RJ-11 jack, for connection of communications elements thereto.

The jack 106 is connected to communications elements, for example, a connector 108 (e.g., a short telephone line). The connector 108 connects to a cordless telephone base unit 110, in conventional manner. The cordless base unit 110 has a corresponding cordless handheld unit 112, comprising a complete cordless telephone. The cordless base unit 110, via the connector 108, connects to the telephone line 104, to enable communications over the telephone line 104. As is conventional, the handheld unit 112 of the cordless telephone communicatively connects to the base unit 110 over radio frequency (RF), such as, for example, over conventional RF channels for cordless telephones—e.g., 900 MHz, 2.4 GHz, or other.

The system 100 also includes a computer 114 or other processing and communications device. The computer 114 can be any of a wide variety of elements, including, for example, a laptop computer, a personal digital assistant, an enhanced telephone, or any other processing and communications device. For example purposes herein, the computer 114 is discussed as though it is a laptop computer equipped with a Universal Serial Bus port, although the description herein should not be construed as limited to such device.

The computer 114 is communicatively connected to cordless telephone handheld unit 112 by a data link 116. The data link 116 provides communications connectivity between the computer 114 and the handheld unit 112. In this description, the data link 116 and its particular design and configuration is intended to and should be broadly construed as any and all elements that provide the communicative connectivity between the computer 114 and the handheld unit 112 hereafter functionally described. Certain particular embodiments of the data link 116 are, nonetheless, detailed.

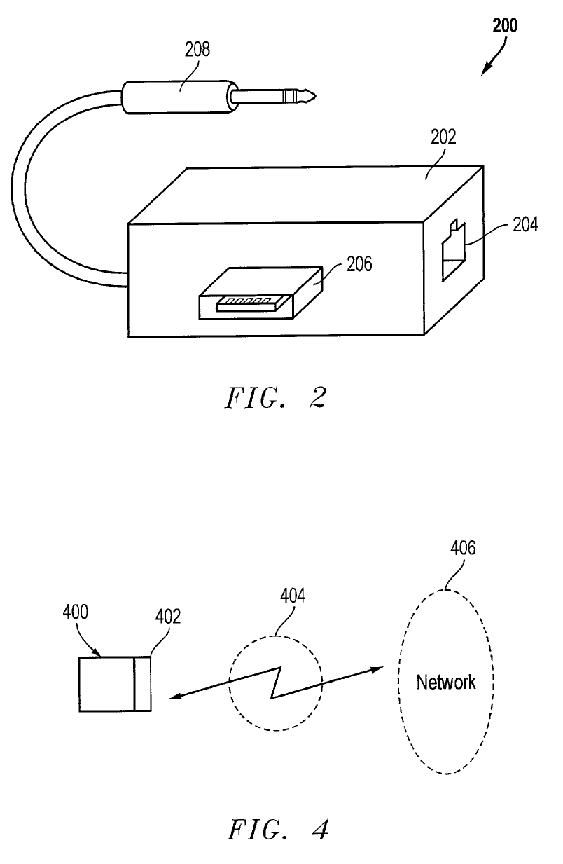

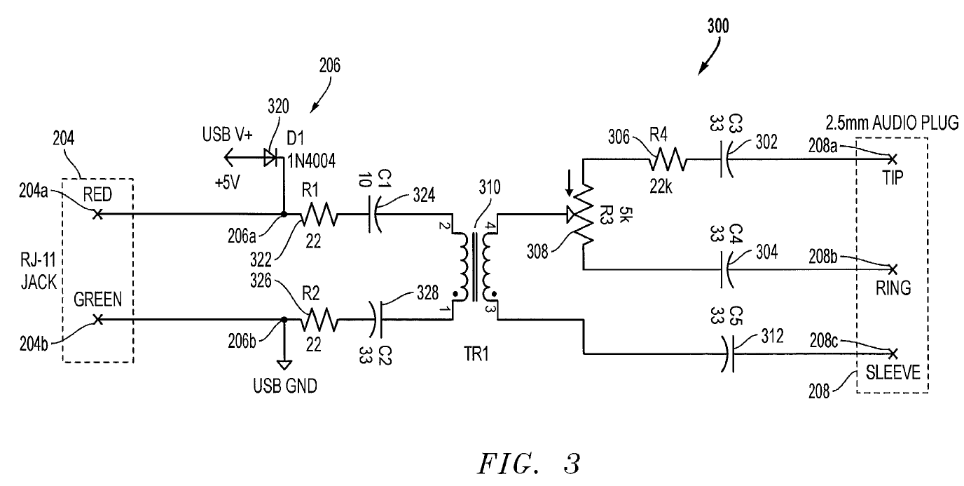

Referring to FIG. 2, an adapter 200 operable as the data link 116 (of FIG. 1) includes a housing 202. The housing 202 can be any of a variety of shapes and sizes sufficient to house elements of a socket 204 (such as an RJ-11 socket), a computer plug 206 (such as a USB male plug), and an audio plug 208 (such as a 1-2.5 mm three conductor audio plug). Within the housing 202 is contained a circuit 300 (not shown in FIG. 2, but shown in FIG. 3 hereafter discussed). The circuit 300 connects to and interconnects the socket 204, the computer plug 206, and the audio plug 208. The housing 202 may be solid or hollow, and may be formed of any of a wide variety of materials, including conductive and non-conductive.

Referring to FIG. 2 in conjunction with FIG. 1, the adapter 200 connects to the computer 114 at a USB socket of the computer 114, by means of the computer plug 206. The adapter 200 connects to the handheld unit 112 at an audio connector receptacle of the handheld unit 112, by means of the audio plug 208. It is noteworthy that the audio plug 208 includes a length of electrical wire to permit ease of arrangement of the handheld unit 112 with respect to the computer 114 in connection therewith. The socket 204 is connectable to an RJ- 11 plug or other telephone line plug, although the socket 204 is not employed in the exemplary embodiment of FIG. 1. Although the adapter 200 is particularly described in the embodiment as having the particular socket 204 and plugs 206, 208, any other socket and plug configurations, suitable for the particular application of communicatively connecting the computer 114 to the handheld unit 112, is intended as included in the embodiments and description.

Referring to FIG. 3, the circuit 300 of the adapter 200 (shown in FIG. 2) includes the computer plug 206 and the audio plug 208, as well as the socket 204. The audio plug 208 is electrically connected at a tip 208 to a first capacitor 302. The first capacitor 302 is, for example, a 33 μF tantalum capacitor. The audio plug 208 is also electrically connected at a ring 208b to a second capacitor 304. The second capacitor 304 is, for example, also a 33 μF tantalum capacitor.

The first capacitor 302 is also electrically connected to a first resistor 302, such as a 22 k resistor (¼Watt). The first resistor 302 and the second capacitor 304 are each electrically connected to and across a trim pot 308, for example, a 5 k trim pot.

The trim pot 308 is electrically connected to a junction of an audio transformer 310. The audio transformer is, for example, a four junction, 1:1 audio transformer, 600 Ohm. Another junction across the audio transformed is electrically connected to a third capacitor 312, such as a 33 μF tantalum capacitor. The third capacitor 312 is electrically connected to a sleeve 208c of the audio plug 208.

As previously mentioned the audio plug 208 of the adapter 200 connects to the handheld unit 112 of the cordless telephone of the system 100.

Continuing to refer to FIG. 3, the jack 204 and the USB plug 206 each connect to the circuit 300. For example, the jack 204 electrically connects to an active side 206a of the USB plug 206 via a red connector 204a of the jack 204. Also, for example, the jack 204, by a green connector 204b of the jack 204, electrically connects to a ground side 206b of the USB plug 206.

The USB plug 206 includes a diode 320 electrically connected to a voltage source (for example, a 5 V source available from the computer 114 at the USB socket of the computer 114). The diode 320 is, for example, a 1N4004 Diode. The diode 320 is also electrically connected to the red connector 204a of the jack 204 and to a second resistor 322. The second resistor 322 is, for example, a 22 k resistor, ½W.

A fourth capacitor 324 electrically connects to the second resistor 322 and also to a junction of the transformer 310. For example, the fourth capacitor 324 is a 10 μF tantalum capacitor.

Across the transformer 310 at another junction thereof, the transformer 310 electrically connects to a fifth capacitor 328. The fifth capacitor 328 is, for example, a 33 μF tantalum capacitor. The fifth capacitor 328 is also electrically connected to a third resistor 326. The third resistor 326 connects to a ground, for example, a ground side 206b of the USB socket of the computer 114. The third resistor326 is, for example, a 22 k resistor, ½W. In the embodiment, the green connector 204b and the third resistor 326 electrically connect to a common ground, such as the ground side 206b of the USB socket of the computer 114.

In operation, the computer 114 and the handheld unit 112 are communicatively (for example, electrically) connected by the data link 116, such as the adapter 200. The handheld unit 112 is communicatively connected to its associated base unit 110, via the conventional wireless RF communications capability of the cordless telephone. The base unit 110 connects to the telephone line 104, for example, by connection elements (e.g., 106, 108). The telephone line 104 communicatively connects with and permits communications with and through the network 102, such as the Internet.

In accessing the network 102 via the computer 114, a user of the computer 114 inputs information at the computer 114 to initiate a dial-up or other connection to and through the network 102. For example, the user has an access account with AOL or some other dial-up Internet service provider. The input at the computer 114 is communicated to the handheld unit 112. The handheld unit 112 communicates over RF with the base unit 110 to initiate the dial-up or other connection protocols directed by the computer 114. The base unit 108 communicates the protocols and information over the connector 108, to and through the telephone line 104 via the connection 106, and then over the Internet or other network 102. In this manner, dial-up connection to a service provider or other accessible device on the network 102 is initiated and commenced.

After initial communications are established between the computer 114, via the cordless telephone, and the network 102, communications continue as desired and directed at the computer 114. The wireless RF communicative connection between the handheld unit 112 and the base unit 110 of the cordless telephone maintains communication connections in order for information to be communicated thereover from and between the computer 114 and the network 102.

Referring to FIG. 4, alternative embodiments include a mobile wireless communications device 400. The device 400 includes mobile and wireless communications elements, such as a modem 402. The modem 402 communicates over a wireless infrastructure 404 connected with a network 406. The wireless infrastructure 404 is any of a wide variety of communications channels and links that, at least in part, are other than wired electrical or optical connectors. Particularly, the wireless infrastructure 404 includes, at least in part, cellular, infrared, microwave, radio frequency, laser or other non-wire communications channels and links. The wireless infrastructure 404 can also include multiple ones of the non-wire communications channels and links. In any event, the wireless infrastructure 404 permits communications with and between the device 400 and the network 406 (including communicative elements located in or communicatively connected to the network 406).

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention.

Benefits, other advantages, and solutions to problems have been described above with regard to specific embodiments. However, the benefits, advantages, solutions to problems and any element(s) that may cause any benefit, advantage, or solution to occur or become more pronounced are not to be construed as a critical, required, or essential feature or element of any or all the claims. As used herein, the terms “comprises, “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A cordless communications system, comprising:
a mobile communications device;
a cordless telephone handheld unit communicatively connected to the mobile communications device;
a cordless telephone base unit communicatively connected to the cordless telephone handheld unit; and
a network communicatively connected to the cordless telephone base unit.

2. The system of claim 1, further comprising:
an adapter communicatively connected to the device and to the handheld unit.

3. The system of claim 2, wherein the adapter comprises:
a first wire connected to the device; and
a second wire connected to the handheld unit.

4. The system of claim 3, wherein the adapter further comprises:
an inductor connected to and between the first wire and the second wire.

5. The system of claim 4, wherein the first wire comprises a Uniform Serial Bus (USB) connector and the second wire comprises an audio plug.

6. The system of claim 5, wherein the adapter further comprises an RJ-11 jack connected to the first wire.

7. The system of claim 1, comprising:
a first wire connected to the device;
a second wire connected to the handheld unit; and
a transformer connected to the first wire and the second wire.

8. The system of claim 7, further comprising:
a diode connected to the first wire and the transformer.

9. The system of claim 8, further comprising:
a trim pot connected to the second wire and the transformer.

10. The system of claim 9, further comprising:
a resistor; and
a capacitor.

11. A circuit for connecting a communications device to a mobile device in radio frequency communication with a fixed device, comprising:
a first wire connected to the communications device;
a transformer connected to the first wire;
a trim pot connected to the transformer;
a second wire connected to the transformer and the mobile device; and
wherein the circuit enables data communications to pass to, from and between each of the communications device and the mobile device, and the mobile device enables data communications to pass to, from and between each of the mobile device and the fixed device.

12. The circuit of claim 11, wherein the fixed device is communicatively connected to a data network, so that the circuit enables the mobile device to communicatively connect to the data network.

13. The circuit of claim 11, wherein the data network is the Internet.

14. An adapter, communicatively connecting a first device to a second device, comprising:
a first connector for connecting the adapter to the first device;
a second connector for connecting the adapter to the second device; and
a transformer connected to the first connector and the second connector.

15. The adapter of claim 14, further comprising:
a diode connected to the first connector and the second connector.

16. The adapter of claim 15, wherein the diode connects to the transformer, the second connector connects to the diode, and the transformer connects to the first connector.

17. The adapter of claim 16, wherein the adapter communicatively connects a computer to a cordless telephone handheld unit.

18. The adapter of claim 17, wherein the cordless telephone handheld unit connects to a cordless telephone base unit, and the computer wirelessly communicates with a network connected to the base unit.

19. A system for wireless data communications, comprising:
a mobile computer;
an adapter connected to the computer;
a mobile wireless communications unit connected to the adapter; and
a wireless communications infrastructure communicatively connected to the mobile wireless communications unit.

20. A method of wireless communications, comprising the step of:
connecting a computer to a cordless telephone handheld unit.

21. The method of claim 20, further comprising:
communicating from the cordless telephone handheld unit to a cordless telephone base unit; and
communicating from the cordless telephone base unit to a network.

22. The method of claim 21, wherein the network is the Internet.

23. The method of claim 21, wherein the step of connecting includes dialing-up, over a telephone system, a network service provider service computer.
